(19) United States
(12) Patent Application Publication
(10) Pub. No.: US 2007/0146280 A1
(43) Pub. Date: Jun. 28, 2007

(54) Liquid crystal display and method for driving the same

(75) Inventor: Wei Wang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/644,078

(22) Filed: Dec. 22, 2006

(30) Foreign Application Priority Data
Dec. 23, 2005 (TW) 94146371

(51) Int. Cl. G09G 3/36

(52) U.S. Cl. 345/94

(57) ABSTRACT

An exemplary liquid crystal display (20) includes: a plurality of parallel scan lines (21); a plurality of parallel data lines orthogonal to the scan lines (22); a plurality of pixel electrodes (25); a plurality of thin-film transistors (23) each positioned near a crossing of a corresponding scan line and a corresponding data line; a plurality of first common electrodes (26), each of the first common electrodes cooperates with a corresponding pixel electrode to form a liquid crystal capacitor (27); a plurality of second common electrodes (28), each of the second common electrodes cooperates with a corresponding pixel electrode to form a capacitor (29); a gate driving circuit (210) providing scanning voltage to the scan lines; a data driving circuit (220) providing driving voltage to the data lines; and a common electrode driving circuit (280) driving the second common electrodes.

### FIELD OF THE INVENTION

The present invention relates to liquid crystal displays (LCDs) including active matrix LCDs, and to methods for driving LCDs including active matrix LCDs.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 4 is an abbreviated circuit diagram of a conventional active matrix LCD. The active matrix LCD 10 includes n rows of parallel scan lines 11 (where n is a natural number), m columns of parallel data lines 12 orthogonal to the n rows of parallel scan lines 11 (where m is also a natural number), a plurality of thin-film transistors (TFTs) 13, a plurality of pixel electrodes 15, a plurality of first common electrodes 16, a plurality of second common electrodes 18, a gate driving circuit 110, and a data driving circuit 120. Each of the TFTs 13 is positioned near a crossing of a corresponding scan line 11 and a corresponding data line 12. A gate electrode 131 of the TFT 13 is electrically coupled to the scan line 11, and a source electrode 132 of the TFT 13 is electrically coupled to the data line 12. Further, a drain electrode 133 of the TFT 13 is electrically coupled to the corresponding pixel electrode 15. Each pixel electrode 15 and a respective one of the first common electrodes 16 cooperatively form a capacitor 17. Each pixel electrode 15 and a respective one of the second common electrodes 18 cooperatively form a capacitor 19. The first common electrodes 16 are electrically connected with the second common electrodes 18. The gate driving circuit 110 provides scanning voltage to the scan lines 11, and the data driving circuit 120 provides driving voltage to the data lines 12.

FIG. 5 shows timing charts illustrating operation of the active matrix LCD 10. Graph (a) illustrates a waveform diagram of voltage supplied to the gate electrode 131 of one TFT 13. Graph (b) illustrates a waveform diagram of voltage supplied to the source electrode 132 of the TFT 13. Graph (c) illustrates a waveform diagram of voltage of the pixel electrode 15. Graph (d) illustrates a waveform diagram of voltage of the first common electrode 16. Graph (e) illustrates a waveform diagram of voltage of the second common electrode 18.

In operation, a first time period T₁ is divided into a display time period T₁₁, and a black insertion time period T₁₂. A second time period T₂ is divided into a display time period T₂₁, and a black insertion time period T₂₂.

During the display time period T₁₁, the gate driving circuit 110 supplies a scanning voltage V_{g} to drive the gate electrode 131 of the TFT 13 via the scan line 11, so as to turn the TFT 13 on. After that, the data driving circuit 120 supplies a driving voltage Vₛ₁₁ to the pixel electrode 15 via the data line 12, the source electrode 132 and the drain electrode 133 of the TFT 13. The gray scale voltage Vₚ₁₁ of the pixel electrode 15 is approximated to the driving voltage Vₛ₁₁ of the data line 12. An external circuit (not shown) supplies a common voltage to the first and second common voltages 16 and 18, and the common voltage V_{com1} of the first common electrode 16 is equal to the common voltage V_{com2} of the second common electrode 18. Thereby, an electric potential is generated between the pixel electrode 15 and the first and second common electrodes 16 and 18 respectively, and the capacitors 17 and 19 are charged. Liquid crystal molecules in a liquid crystal layer at the electrodes 15, 16, 18 may be twisted according to the electric potential. When the TFT 13 is turned off, the capacitors 17 and 19 maintain the electric potential for driving the liquid crystal molecules.

During the display time period T₁₂, the gate driving circuit 110 supplies a scanning voltage V_{g} to drive the gate electrode 131 of the TFT 13 via the scan line 11, so as to turn the TFT 13 on. After that, the data driving circuit 120 supplies a black insertion voltage Vₛ₁₂ to the pixel electrode 15 via the data line 12, the source electrode 132 and the drain electrode 133 of the TFT 13. The gray scale voltage Vₚ₁₂ of the pixel electrode 15 is approximated to the driving voltage Vₛ₁₂ of the data line 12. The common voltages V_{com1} and V_{com2} are maintained. Thereby, an electric potential is generated between the pixel electrode 15 and the first and second common electrodes 16 and 18, respectively, and the liquid crystal molecules may be completely twisted, due to the relationship whereby Vₚ₁₂−V_{com1}>Vₚ₁₁−V_{com1}. When the liquid crystal molecules are completely twisted, the LCD 10 displays a black image.

During the display time period T₂₁, the gate driving circuit 110 supplies a scanning voltage V_{g} to drive the gate electrode 131 of the TFT 13 via the scan line 11, so as to turn the TFT 13 on. After that, the data driving circuit 120 supplies a driving voltage Vₛ₂₁ to the pixel electrode 15 via the data line 12, the source electrode 132 and the drain electrode 133 of the TFT 13. The gray scale voltage Vₚ₂₁ of the pixel electrode 15 is approximated to the driving voltage Vₛ₂₁ of the data line 12. The common voltages V_{com1} and V_{com2} are maintained, and the LCD 10 is inversion driven during the second time period T₂. That is, Vₛ₂₁−V_{com1}=−(Vₛ₁₁−V_{com1}), Vₚ₂₁−V_{com1}=−(Vₚ₁₁−V_{com1}). Thereby, an electric potential is generated between the pixel electrode 15 and the first and second common electrodes 16 and 18 respectively, and the capacitors 17 and 19 are charged. The liquid crystal molecules may be twisted according to the electric potential. When the TFT 13 is turned off, the capacitors 17 and 19 maintain the electric potential for driving the liquid crystal molecules.

During the display time period T₂₂, the gate driving circuit 110 supplies a scanning voltage V_{g} to drive the gate electrode 131 of the TFT 13 via the scan line 11, so as to turn the TFT 13 on. After that, the data driving circuit 120 supplies a black insertion voltage Vₛ₂₂ to the pixel electrode 15 via the data line 12, the source electrode 132 and the drain electrode 133 of the TFT 13. The gray scale voltage Vₚ₂₂ of the pixel electrode 15 is approximated to the driving voltage Vₛ₂₂ of the data line 12. The common voltages V_{com1} and V_{com2} are maintained. Thereby, an electric potential is generated between the pixel electrode 15 and the first and second common electrodes 16 and 18, respectively, and the liquid crystal molecules may be completely twisted, due to the relationship whereby |Vₚ₂₂−V_{com1}|>|Vₚ₂₁−V_{com1}|. When the liquid crystal molecules are completely twisted, the LCD 10 displays a black image.

However, the LCD 10 use a gate driving circuit 110 to provide the scanning voltage Vg and a data driving circuit 120 to provide the black insertion voltage for realizing black insertion. The clock periods of the gate driving circuit 110 and the date driving circuit 120 need to be changed, which make the driving process of the LCD 10 unduly complicated.

It is desired to provide an LCD and method of driving the LCD which can overcome the above-described deficiencies.

### SUMMARY

An exemplary liquid crystal display includes: a plurality of parallel scan lines; a plurality of parallel data lines orthogonal to the scan lines; a plurality of pixel electrodes; a plurality of thin-film transistors each positioned near a crossing of a corresponding scan line and a corresponding data line; a plurality of first common electrodes, each of the first common electrodes cooperates with a corresponding pixel electrode to form a liquid crystal capacitor; a plurality of second common electrodes, each of the second common electrodes cooperates with a corresponding pixel electrode to form a capacitor; a gate driving circuit providing scanning voltage to the scan lines; a data driving circuit providing driving voltage to the data lines; and a common electrode driving circuit driving the second common electrodes.

Another exemplary liquid crystal display includes: a plurality of parallel scan lines; a plurality of parallel data lines orthogonal to the scan lines; a plurality of pixel electrodes; a plurality of thin-film transistors each positioned near a crossing of a corresponding scan line and a corresponding data line; a plurality of first common electrodes, each of the first common electrodes cooperates with a corresponding pixel electrode to form a liquid crystal capacitor; a plurality of second common electrodes, each of the second common electrodes cooperates with a corresponding pixel electrode to form a capacitor; a gate driving circuit providing scanning voltage to the scan lines, and driving the second common electrodes; and a data driving circuit providing driving voltage to the data lines.

An exemplary method for driving a liquid crystal display is also provided. The liquid crystal display has a plurality thin-film transistors, a plurality of pixel electrodes, a plurality of first common electrodes, and a plurality of second common electrodes. The method includes: dividing a time period into a display time period, and a black insertion time period; during the display time period, turning on the thin-film transistors, providing a common voltage to the first common electrodes, and providing a driving voltage to the second common electrodes, the driving voltage being equal to the common voltage; and during the black insertion time period, providing a black insertion voltage to the second common electrodes.

Advantages and novel features of the liquid crystal display and driving method will become more apparent from the following detailed description when taken in conjunction with the accompanying drawings, in which:

### BRIEF DESCRIPTION OF THE DRAWINGS

FIG. 1 is an abbreviated circuit diagram of an active matrix LCD according to a first embodiment of the present invention;

FIG. 2 shows timing charts illustrating operation of the LCD of FIG. 1;

FIG. 3 is an abbreviated circuit diagram of an active matrix LCD according to a second embodiment of the present invention;

FIG. 4 is an abbreviated circuit diagram of a conventional LCD; and

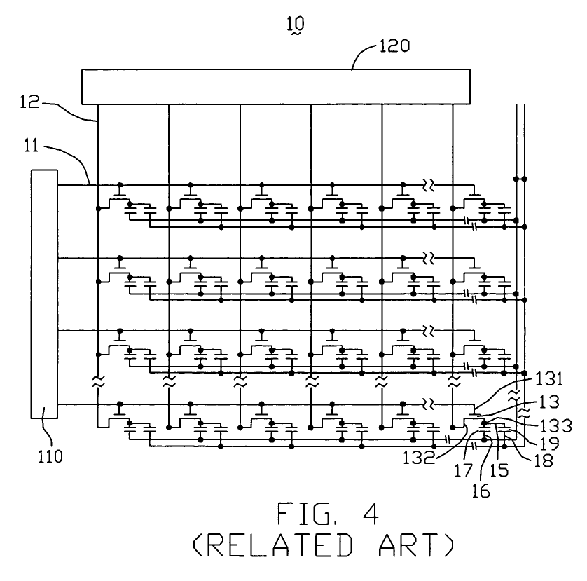

FIG. 5 shows timing charts illustrating operation of the LCD of FIG. 4.

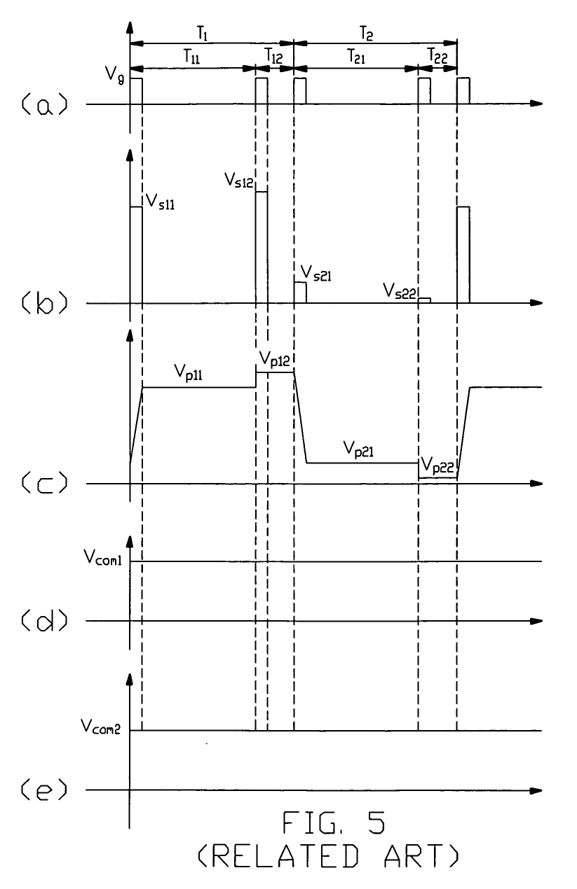

### DETAILED DESCRIPTION OF PREFERRED EMBODIMENTS

Reference will now be made to the drawings to describe preferred and exemplary embodiments of the present invention in detail.

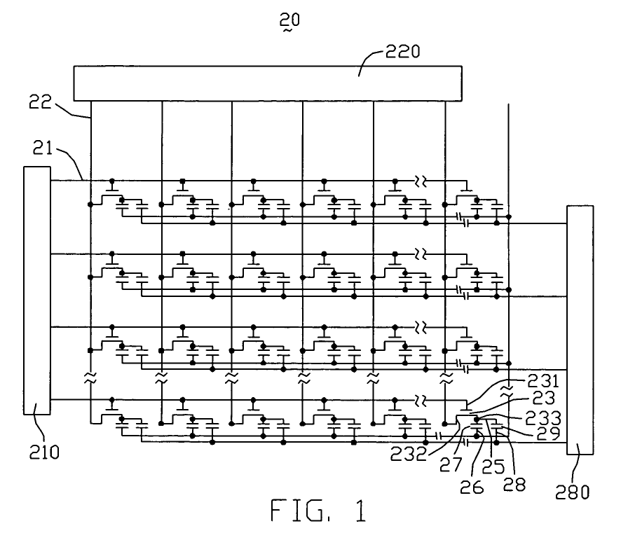

FIG. 1 is an abbreviated circuit diagram of an active matrix LCD according to a first embodiment of the present invention. The active matrix LCD 20 includes n rows of parallel scan lines 21 (where n is a natural number), m columns of parallel data lines 22 orthogonal to the n rows of parallel scan lines 21 (where m is also a natural number), a plurality of thin-film transistors (TFTs) 23, a plurality of pixel electrodes 25, a plurality of first common electrodes 26, a plurality of second common electrodes 28, a gate driving circuit 210, a data driving circuit 220, and a common electrode driving circuit 280. Each of the TFTs 23 is positioned near a crossing of a corresponding scan line 21 and a corresponding data line 22. A gate electrode 231 of the TFT 23 is electrically coupled to the scan line 21, and a source electrode 232 of the TFT 23 is electrically coupled to the data line 22. Further, a drain electrode 233 of the TFT 23 is electrically coupled to the corresponding pixel electrode 25. Each pixel electrode 25 and a respective one of the first common electrodes 26 cooperatively form a capacitor 17. Each pixel electrode 25 and a respective one of the second common electrodes 28 cooperatively form a capacitor 29. The gate driving circuit 210 provides scanning voltage to the scan lines 21, and the data driving circuit 220 provides driving voltage to the data lines 22. Further, the common electrode driving circuit 280 provides driving voltage and black insertion voltage to the second common electrodes 28.

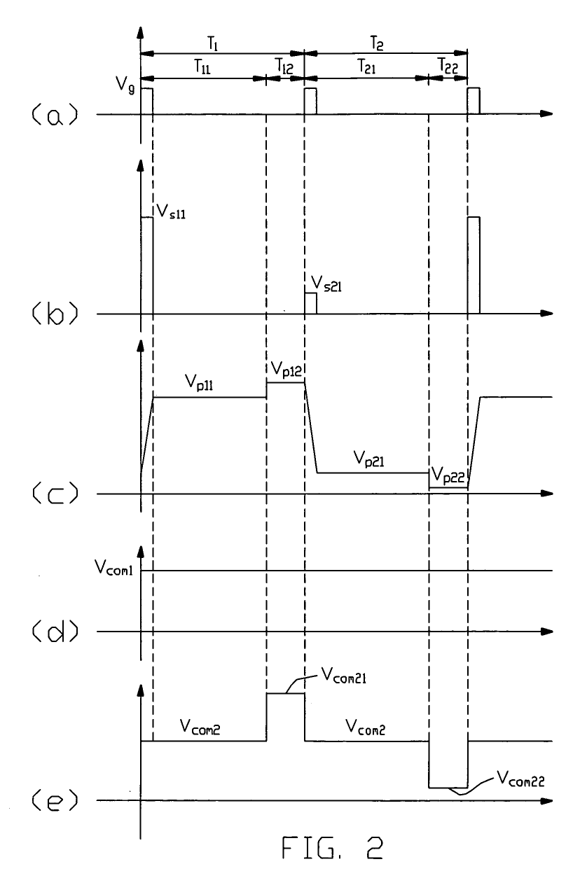

FIG. 2 shows timing charts illustrating operation of the LCD 20. Graph (a) illustrates a waveform diagram of voltage supplied to the gate electrode 231 of one TFT 23. Graph (b) illustrates a waveform diagram of voltage supplied to the source electrode 232 of the TFT 23. Graph (c) illustrates a waveform diagram of voltage of the pixel electrode 25. Graph (d) illustrates a waveform diagram of voltage of the first common electrode 26. Graph (e) illustrates a waveform diagram of voltage of the second common electrode 28.

In operation, a first time period T₁ is divided into a display time period T₁₁, and a black insertion time period T₁₂. A second time period T₂ is divided into a display time period T₂₁, and a black insertion time period T₂₂.

During the display time period T₁₁, the gate driving circuit 210 supplies a scanning voltage V_{g} to drive the gate electrode 231 of the TFT 23 via the scan line 21, so as to turn the TFT 23 on. After that, the data driving circuit 220 supplies a driving voltage Vₛ₁₁ to the pixel electrode 25 via the data line 22, the source electrode 232 and the drain electrode 233 of the TFT 23. The gray scale voltage Vₚ₁₁ of the pixel electrode 25 is approximated to the driving voltage Vₛ₁₁ of the data line 22. An external circuit (not shown) supplies a common voltage V_{com1} to the first common voltages 26, and the common electrode driving circuit 280 supplies a common voltage V_{com2} to the second common electrode 28, whereby, V_{com2} is equal to V_{com1}. Thereby, an electric potential is generated between the pixel electrode 25 and the first and second common electrodes 26 and 28 respectively, and the capacitors 27 and 29 are charged. Liquid crystal molecules in a liquid crystal layer between the pixel electrode 25 and the first common electrode 26 may be twisted according to a corresponding electric potential. When the TFT 23 is turned off, the capacitors 27 and 29 maintain the electric potential for driving the liquid crystal molecules between the pixel electrode 25 and the first common electrode 26.

During the display time period T₁₂, the common electrode driving circuit 280 supplies a black insertion voltage V_{com21} to the second common electrode 28, and V_{com21}>Vₚ₁₁>V_{com1}. At this time, the two capacitors 27 and 29 are equivalent to being connected in series between the first common electrode 26 and the second common electrode 28. The TFT 23 is turned off, and the pixel electrode 25 is disconnected. Thereby, the two capacitors 27 and 29 divide the voltage between the first and second common electrodes 26 and 28. The voltage of the pixel electrode 25 is changed from Vₚ₁₁ to Vₚ₁₂, and Vₚ₁₂ is determined by the black insertion voltage V_{com21} and the capacitance of the capacitors 27 and 29. That is, the electric potential between the voltage Vₚ₁₂ and the voltage V_{com1} can be controlled via adjusting the black insertion voltage V_{com21} and the capacitance of the capacitors 27 and 29. The electric potential between the pixel electrode 25 and the first common electrode 26 is able to drive the liquid crystal molecules to completely twist. When the liquid crystal molecules are completely twisted, the LCD 20 displays a black image.

During the display time period T₂₁, the gate driving circuit 210 supplies a scanning voltage V_{g} to drive the gate electrode 231 of the TFT 23 via the scan line 21, so as to turn the TFT 23 on. After that, the data driving circuit 120 supplies a driving voltage Vₛ₂₁ to the pixel electrode 25 via the data line 22, the source electrode 232 and the drain electrode 233 of the TFT 23. The gray scale voltage Vₚ₂₁ of the pixel electrode 25 is approximated to the driving voltage Vₛ₂₁ of the data line 22. The common voltage V_{com1} supplied to the first common electrode 26 is maintained, and the common voltage V_{com21} is changed to V_{com2}. The LCD 20 is inversion driven during the second time period T₂. That is, Vₛ₂₁−V_{com1}=−(Vₛ₁₁−V_{com1}), Vₚ₂₁−V_{com1}=−(Vₚ₁₁−V_{com1}). Thereby, an electric potential is generated between the pixel electrode 25 and the first and second common electrodes 26 and 28 respectively, and the capacitors 27 and 29 are charged. The liquid crystal molecules between the pixel electrode 25 and the first common electrode 26 may be twisted according to a corresponding electric potential. When the TFT 23 is turned off, the capacitors 27 and 29 maintain the electric potential for driving the liquid crystal molecules between the pixel electrode 25 and the first common electrode 26.

During the display time period T₂₂, the common electrode driving circuit 280 supplies a black insertion voltage V_{com22} to the second common electrode 28, and V_{com22}<Vₚ₂₁<V_{com1}. At this time, the two capacitors 27 and 29 are equivalent to being connected in series between the first common electrode 26 and the second common electrode 28. The TFT 23 is turned off, and the pixel electrode 25 is disconnected. Thereby, the two capacitors 27 and 29 divide the voltage between the first and second common electrodes 26 and 28. The voltage of the pixel electrode 25 is changed form Vₚ₂₁ to Vₚ₂₂, and Vₚ₂₂ is determined by the black insertion voltage V_{com21} and the capacitance of the capacitors 27 and 29. That is, the electric potential between the voltage Vₚ₂₂ and the voltage V_{com1} can be controlled via adjusting the black insertion voltage V_{com22} and the capacitance of the capacitors 27 and 29. The electric potential between the pixel electrode 25 and the first common electrode 26 is able to drive the liquid crystal molecules to completely twist. When the liquid crystal molecules are completely twisted, the LCD 20 displays a black image.

The LCD 20 only needs to change the driving voltage supplied to the second common voltage 28, so as to enable the driving voltage of the second common electrode 28 to vary in three levels for realizing a black insertion process. The LCD 20 realizes black insertion driving without changing the driving process of the gate driving circuit 210 and the data driving circuit 220 thereof, which makes the driving process of the LCD 20 efficient.

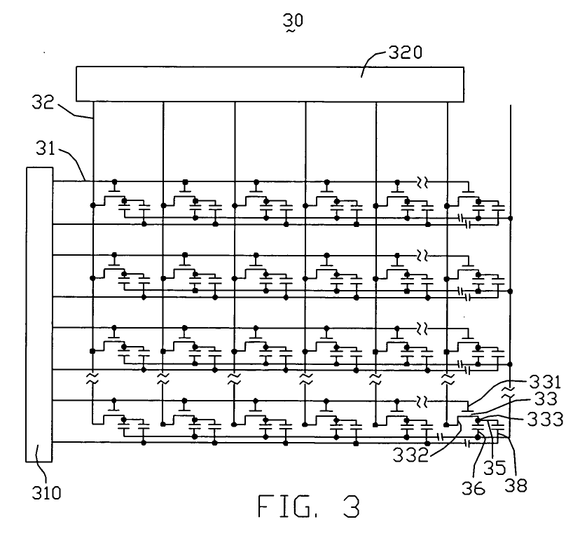

Referring to FIG. 3, an abbreviated circuit diagram of an active matrix LCD according to a second embodiment of the present invention is shown. The active matrix LCD 30 has a structure similar to that of the LCD 20. However, the LCD 30 has no common electrode driving circuit, and second common electrodes 38 are electrically coupled to and driven by a gate driving circuit 310.

During a display time period, a gate driving circuit 310 supplies a scanning voltage to drive a gate electrode 331 of each of TFTs 33 via a corresponding one of scan lines 31, so as to turn the TFT 33 on. After that, a data driving circuit 320 supplies a driving voltage to a corresponding one of pixel electrodes 35 via a corresponding one of data lines 32 and a source electrode 332 and a drain electrode 333 of the TFT 33. An external circuit (not shown) supplies a common voltage to a corresponding one of first common electrodes 36, and the gate driving circuit 310 supplies a common voltage to the corresponding second common electrode 38. The common voltage supplied to the first common electrode 36 is equal to that supplied to the second common electrode 38. Thereby, liquid crystal molecules in a liquid crystal layer between the pixel electrode 35 and the first common electrode 36 may be driven to twist according to a corresponding electric potential between the pixel electrode 35 and the first common electrode 36. In the black insertion time period, the gate driving circuit 310 supplies a black insertion voltage to the second common electrode 38 for enabling the LCD 30 to display a black image.

In alternative embodiments, for example, the voltage of the first common electrode of each TFT may be supplied by the gate driving circuit, the data driving circuit, or the common electrode driving voltage.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A liquid crystal display, comprising:
a plurality of parallel scan lines;
a plurality of parallel data lines orthogonal to the scan lines;
a plurality of pixel electrodes;
a plurality of thin-film transistors each positioned near a crossing of a corresponding scan line and a corresponding data line;
a plurality of first common electrodes, each of the first common electrodes cooperating with a corresponding pixel electrode to form a liquid crystal capacitor;
a plurality of second common electrodes, each of the second common electrodes cooperating with a corresponding pixel electrode to form a capacitor;
a gate driving circuit providing scanning voltage to the scan lines;
a data driving circuit providing driving voltage to the data lines; and
a common electrode driving circuit driving the second common electrodes.

2. A liquid crystal display, comprising:
a plurality of parallel scan lines;
a plurality of parallel data lines orthogonal to the scan lines;
a plurality of pixel electrodes;
a plurality of thin-film transistors each positioned near a crossing of a corresponding scan line and a corresponding data line;
a plurality of first common electrodes, each of the first common electrodes cooperating with a corresponding pixel electrode to form a liquid crystal capacitor;
a plurality of second common electrodes, each of the second common electrodes cooperating with a corresponding pixel electrode to form a capacitor;
a gate driving circuit providing scanning voltage to the scan lines, and driving the second common electrodes; and
a data driving circuit providing driving voltage to the data lines.

3. A method for driving a liquid crystal display, the liquid crystal display comprising a plurality thin-film transistors, a plurality of pixel electrodes, a plurality of first common electrodes, and a plurality of second common electrodes, the method comprising:
dividing a time period into a display time period and a black insertion time period;
during the display time period, turning on the thin-film transistors, providing a common voltage to the first common electrodes, and providing a driving voltage to the second common electrodes, the driving voltage being equal to the common voltage; and
during the black insertion time period, providing a black insertion voltage to the second common electrodes.

4. The method as claimed in claim 3, wherein during the display time period, a voltage of the pixel electrodes is larger than the common voltage; and during the black insertion time period, the black insertion voltage of the second common electrodes is larger than the voltage of the pixel electrodes.

5. The method as claimed in claim 3, wherein during the display time period, a voltage of the pixel electrodes is less than the common voltage; and during the black insertion time period, the black insertion voltage of the second common electrodes is less than the voltage of the pixel electrodes.

6. The method as claimed in claim 3, wherein the second common electrodes are driven by a common electrode driving circuit of the liquid crystal display.

7. The method as claimed in claim 3, wherein the second common electrodes are driven by a gate driving circuit of the liquid crystal display.
